(19) United States
(12) Patent Application Publication
(10) Pub. No.: US 2016/0343249 A1
(43) Pub. Date: Nov. 24, 2016

(54) METHODS AND DEVICES FOR PROCESSING TRAFFIC DATA

(71) Applicant: Xiaomi Inc., Beijing (CN)

(72) Inventors: Yi GAO, Beijing (CN); Yunyuan GE, Beijing (CN); Zhengan WANG, Beijing (CN)

(73) Assignee: Xiaomi Inc., Beijing (CN)

(21) Appl. No.: 15/160,425

(22) Filed: May 20, 2016

(30) Foreign Application Priority Data
May 22, 2015 (CN) 201510268273.9

(51) Int. Cl. G08G 1/01; G08G 1/0968; H04W 4/02; G08G 1/0967

(52) U.S. Cl. CPC G08G 1/0133; G08G 1/096775; G08G 1/096811; H04W 4/023

(57) ABSTRACT

The present disclosure relates to methods and devices for processing traffic data. A method may include acquiring a current location of a traveling vehicle. A method may further include, when the current location is not an identified traffic impediment location, monitoring an amount of variation of an impediment parameter when the vehicle is in the current location. A method may further include, when the amount of variation of the impediment parameter exceeds a predetermined range, sending the current location and the amount of variation of the impediment parameter to a traffic data server. Through a method, drivers may in real time learn accurate information about traffic impediments ahead, and may preemptively respond by lowering traveling speeds or bypassing the location.

### CROSS-REFERENCE TO RELATED APPLICATIONS

The present application is based upon and claims priority to Chinese Patent Application No. 201510268273.9 filed May 22, 2015, the entire contents of which are incorporated herein by reference.

### TECHNICAL FIELD

The present disclosure generally relates to the field of vehicle technology, and more particularly, to methods and devices for processing traffic data.

### BACKGROUND

During traveling, a driver inevitably encounters poor road conditions, such as a damaged road surface, road construction, road obstructions, etc. These factors influencing normal traveling of a vehicle may be collectively referred to as traffic impediments. When a vehicle is traveling fast or with poor ambient light, if a traffic impediment exists in the road ahead and the driver fails to appropriately slow down or steer away, it may cause wearing of tires or even a traffic accident. Accordingly, it may be important for the safety of the driver and the vehicle to learn about locations of traffic impediments in advance.

Currently, a driver may generally be informed of a location of a traffic impediment through a traffic radio station. For example, if a driver finds a traffic impediment in a road ahead, he may dial a hotline of a traffic radio station and describes the location, the type and other aspects of the traffic impediment. Then, the traffic radio station broadcasts the situations of the traffic impediment to other drivers who are listening to the traffic radio station, to alert the drivers who are approaching the location of the traffic impediment to slow down or pay more attention in advance, so as to avoid bad effects of the traffic impediment on the normal traveling of the vehicle.

However, not all drivers will inform other drivers of traffic impediments they encounter through a traffic radio station, and not all drivers will be listening to the traffic radio station at a given time. Therefore, many traffic impediments are not known to every driver. Additionally, even if a driver learns about a traffic impediment through a traffic radio station or by having personally come across a traffic impediment before, that traffic impediment may have been subsequently currently cleared, but the driver may nevertheless still consider that traffic impediment as existing and may thus select another road to bypass it. This will unnecessarily prolong the traveling time and if the driver is not familiar with another road, it may become difficult for him to arrive at the destination.

### SUMMARY

According to a first aspect of embodiments of the present disclosure, there is provided a method for processing traffic data, which is applied in a terminal. The method may include acquiring a current location of a traveling vehicle. The method may further include determining whether the current location is an identified traffic impediment location. The method may further include, when the current location is not an identified traffic impediment location, monitoring an amount of variation of an impediment parameter when the vehicle is in the current location. The method may further include, when the current location is not an identified traffic impediment location, determining whether the amount of variation of the impediment parameter exceeds a corresponding predetermined range. The method may further include, when the amount of variation of the impediment parameter exceeds the predetermined range, sending the current location and the amount of variation of the impediment parameter to a traffic data server.

According to a second aspect of embodiments of the present disclosure, there is provided a method for processing traffic data, which is applied in a server. A method may include receiving, from a first vehicle, a current location of the first vehicle and an amount of variation of an impediment parameter of the first vehicle. The method may further include determining whether the current location corresponds to a location previously stored in a traffic-impediment-location list in the server. The method may further include, when the current location does not correspond to a location previously stored in the traffic-impediment-location list, identifying the current location as a traffic impediment location. The method may further include, when the current location does not correspond to a location previously stored in the traffic-impediment-location list, storing the amount of variation of the impediment parameter locally in the server. The method may further include, when the current location does not correspond to a location previously stored in the traffic-impediment-location list, storing the current location in the traffic-impediment-location list.

According to a third aspect of embodiments of the present disclosure, there is provided a terminal. The terminal may include a processor and a memory for storing instructions executable by the processor. The processor may be configured to acquire a current location of a traveling vehicle. The processor may be further configured to determine whether the current location of the vehicle is an identified traffic impediment location. The processor may be further configured to, when the current location of the vehicle is not an identified traffic impediment location, monitor an amount of variation of an impediment parameter when the vehicle is in the current location. The processor may be further configured to, when the current location of the vehicle is not an identified traffic impediment location, determine whether the amount of variation of the impediment parameter exceeds a corresponding predetermined range. The processor may be further configured to, when the amount of variation of the impediment parameter exceeds the predetermined range, send the current location and the amount of variation of the impediment parameter to a traffic data server.

According to a fourth aspect of embodiments of the present disclosure, there is provided a server. The server may include a processor and a memory for storing instructions executable by the processor. The processor may be configured to receive, from a first vehicle, a current location of the first vehicle and an amount of variation of an impediment parameter of the first vehicle. The processor may be further configured to determine whether the current location corresponds to a location previously stored in a traffic-impediment-location list in the server. The processor may be further configured to, when the current location does not correspond to a location previously stored in the traffic-impediment-location list, identify the current location as a traffic impediment location. The processor may be further configured to, when the current location does not correspond to a location previously stored in the traffic-impediment list, store the amount of variation of the impediment parameter locally in the server. The processor may be further configured to, when the current location does not correspond to a location previously stored in the traffic-impediment list, store the current location in the traffic-impediment-location list.

### BRIEF DESCRIPTION OF THE DRAWINGS

In order to illustrate the technical solutions of the embodiments of the present disclosure or the related art more clearly, a brief introduction if given hereinafter with reference to the accompanying drawings, which may be used to describe embodiments or related art. Other embodiments may be apparent to those skilled in the art based on these drawings without creative labor.

FIG. 1 is a flow chart illustrating a method for processing traffic data according to an exemplary embodiment;

FIG. 2 is a schematic diagram illustrating a vehicle traveling at a traffic impediment;

FIG. 3 is a flow chart illustrating a method for processing traffic data according to an exemplary embodiment;

FIG. 4 is a flow chart illustrating a method for processing traffic data according to an exemplary embodiment;

FIG. 5 is a flow chart illustrating a method for processing traffic data according to an exemplary embodiment;

FIG. 6 is a flow chart illustrating a method for processing traffic data according to an exemplary embodiment;

FIG. 7 is a flow chart illustrating a method for processing traffic data according to an exemplary embodiment;

FIG. 8 is a schematic diagram illustrating an identified traffic impediment location marked on a traveling route in a map;

FIG. 9 is a flow chart illustrating a method for processing traffic data according to an exemplary embodiment;

FIG. 10 is a flow chart illustrating a method for processing traffic data according to an exemplary embodiment;

FIG. 11 is a flow chart illustrating a method for processing traffic data according to an exemplary embodiment;

FIG. 12 is a flow chart illustrating a method for processing traffic data according to an exemplary embodiment;

FIG. 13 is a block diagram of a device for processing traffic data according to an exemplary embodiment;

FIG. 14 is a block diagram of a device for processing traffic data according to an exemplary embodiment;

FIG. 15 is a block diagram of a server according to an exemplary embodiment;

FIG. 16 is a block diagram of a terminal according to an exemplary embodiment; and

FIG. 17 is a block diagram of a server according to an exemplary embodiment.

### DETAILED DESCRIPTION

In order to for those skilled in the art to better understand technical solutions of the present disclosure, technical solutions of the present disclosure will be described more clearly and fully with reference to the accompanying drawings of embodiments. It is apparent that the described embodiments are only a part of but not all of the embodiments within the scope of the present disclosure. Other embodiments of the present disclosure will be readily apparent to one of ordinary skill in the art in view of the present disclosure, all of which are encompassed by the protective scope of the present disclosure.

FIG. 1 is a flow chart illustrating a method for processing traffic data according to an exemplary embodiment, which may be applied in a terminal installed onboard a vehicle. As shown in FIG. 1, an exemplary method may include the following steps.

In step S101, a current location of a traveling vehicle is acquired.

A navigation device may be installed onboard the vehicle in advance, and the driver may find a route according to the navigation device. For a vehicle without a navigation device, the driver may carry a mobile phone, a tablet computer, or the like, which is equipped with a navigation system, to find a route.

In an embodiment of the present disclosure, an onboard navigation device or a terminal equipped with a navigation system may each be referred to as a navigation terminal. Generally, a navigation terminal has a positioning function and may acquire location data of the navigation terminal in real time. The location data may be latitude and longitude coordinates, or may be a geographical name such as a name of a street or a name of a residence community, etc.

The current location data, that is, the current location of the traveling vehicle may be acquired through known navigation systems, such as satellite-based global positioning systems (GPS), or the like. The current location of the vehicle may be thereby acquired.

In step S102, it is determined whether the current location is an identified traffic impediment location.

Generally, identified traffic impediment locations and information about identified traffic impediment locations may be loaded, stored, or preset, in the navigation terminal or in a traffic data server in advance. However, identified traffic impediment locations and information about identified traffic impediment locations may also be updated periodically.

In an embodiment of the present disclosure, after an identified traffic impediment location is acquired, the step of determining whether the current location is an identified traffic impediment location may include determining whether the current location is the same as an identified traffic impediment location. When it is determined that the current location is the same as an identified traffic impediment location, it is determined that the current location is an identified traffic impediment location. Otherwise, it is determined that the current location is not an identified traffic impediment location

During operation of the vehicle, the navigation system may have errors, such that even if the vehicle is practically at an identified traffic impediment location, the current location of the vehicle as acquired through the navigation system may be different from that identified traffic impediment location. Thus, in an embodiment of the present disclosure, the step of determining whether the current location is at the same location as an identified traffic impediment location may also include determining whether the current location of the vehicle is within a predetermined range of an identified traffic impediment location, wherein the predetermined range may be a range centered at an identified traffic impediment location and having a radius of a predetermined distance (for example 1 meter). When the current location of the vehicle is within the range, it may be determined that the current location is an identified traffic impediment location, otherwise, it may be determined that the current location is not an identified traffic impediment location.

The vehicle may obtain an identified traffic impediment location from a server. For example, the server may send to the vehicle all identified traffic impediment locations in a district or a city that the vehicle is in. Alternatively or additionally, when the server learns about a traveling route of the vehicle, the server may send to the vehicle identified traffic impediment locations on the traveling route.

The current location of the traveling vehicle acquired in step S101 is compared with each of the identified traffic impediment locations. When the current location of the vehicle is the same as any of the identified traffic impediment locations, or when the current location of the vehicle is within the predetermined range of any of the identified traffic impediment locations, it may be determined that the current location of the vehicle is an identified traffic impediment location. Otherwise, it may be determined that the current location of the vehicle is not an identified traffic impediment location, and the process turns to step S103.

In step S103, when the current location of the vehicle is not an identified traffic impediment location, an amount of variation of an impediment parameter is monitored when the vehicle is in the current location.

For a respective vehicle, some respective impediment parameters may be decided in advance as being relevant, such as vehicle vibration, steering wheel angle, and engine rotational speed. Accordingly, the vehicle may be installed with corresponding sensors which are disposed on the body of the vehicle, the steering wheel, and the engine.

In order to collect these parameters, an on-board information system may be installed onboard the vehicle in advance. The on-board information system may be connected to the impediment parameter sensors, for acquiring the parameters collected by the sensors as impediment parameters, such as amplitude of vibration of the vehicle, turning angle of the vehicle, etc. An exemplary impediment parameter sensor may be a portable vibration analyzer, such as an LC-2200 vibrometer or the like. An exemplary impediment parameter sensor may be a sensor to directly measure turning angle. An exemplary impediment parameter sensor may be a system to measure turning angle that includes a steering wheel rotational angle sensor connected to the on-board information system, with the on-board information system configured to calculate turning angle based upon a known relationship between a signal from the steering wheel rotational angle sensor and the turning angle.

The navigation terminal may be connected to the on-board information system via cables or via wireless connection, such that the navigation terminal may acquire impediment parameters from the on-board information system in real time. In an embodiment of the present disclosure, a impediment parameter refers to a combination of one or more parameters which indicates that the vehicle encounters a traffic impediment.

When a vehicle is traveling normally, parameters of the body and driving system of the vehicle will not dramatically change. When the vehicle encounters a traffic impediment, those parameters may change significantly. Therefore, an amount of variation of an impediment parameter may indicate whether the vehicle encounters a traffic impediment.

In an embodiment of the present disclosure, an amount of variation of vibration amplitude of the vehicle is described as an example. The amount of variation of vibration amplitude may represent a variation of vertical vibration of a vehicle component.

An amount of variation of an impediment parameter may be a difference between the current vibration amplitude of the vehicle and a vibration amplitude of the vehicle at a predetermined moment, for example, a difference between the current vibration amplitude of the vehicle and a vibration amplitude of the vehicle 1 second ago. An amount of variation of the impediment parameter may also be a difference between the current vibration amplitude of the vehicle and a predetermined vibration amplitude of the vehicle. A predetermined vibration amplitude of the vehicle may be an average value of vibration amplitudes of the vehicle traveling on a flat road. It may be determined whether the vehicle's traveling significantly changes by acquiring the amount of variation of an impediment parameter.

In step S104, it is determined whether the amount of variation of an impediment parameter exceeds a corresponding predetermined range.

As described in the above step S103, an impediment parameter may be a combination of one or more parameters. For any two different parameters, because they may have different attributes or be of different types, each of the impediment parameters will be set with a respective corresponding predetermined range. For example, vibration amplitude may correspond to a predetermined range [10, 20] of vibration amplitude.

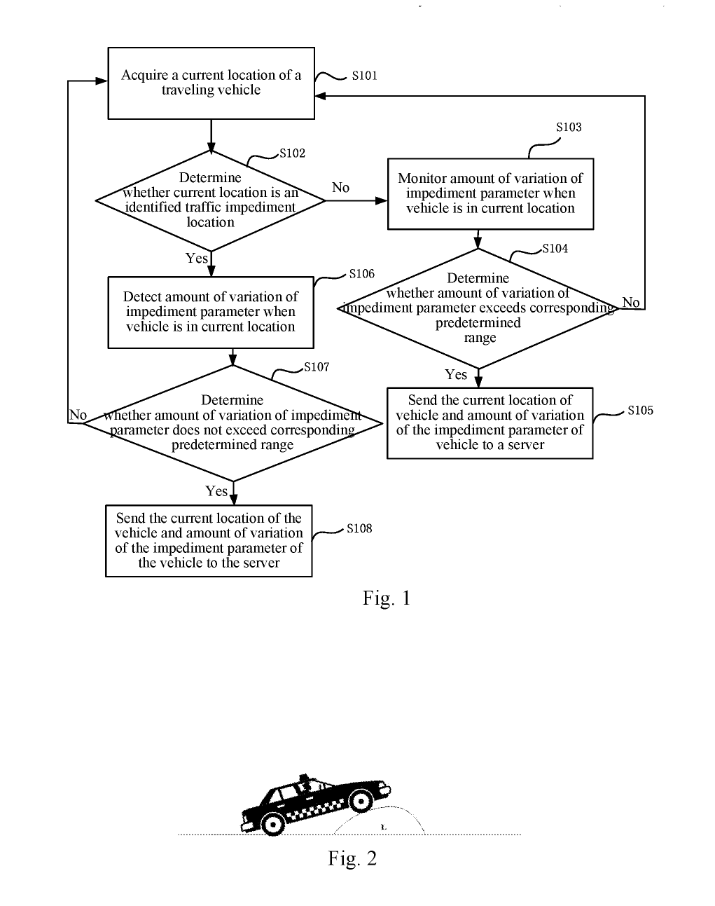

When the amount of variation of an impediment parameter is within the corresponding predetermined range, the amount of variation of the impediment parameter may be considered to be in a reasonable range, and the vehicle may be considered to currently be traveling normally. When the amount of variation of the impediment parameter exceeds the corresponding predetermined range, the amount of variation of the impediment parameter exceeds the set range, and the vehicle could currently be encountering a traffic impediment in its traveling. An amount of variation of an impediment parameter may exceed a corresponding predetermined range by having a value outside of that range, for example by having a value larger than the maximum value of that range, or smaller than the minimum value of that range, depending upon the nature of that impediment parameter. End-point values of a range may be within that range. As shown in FIG. 2, when, for example, the vehicle encounters a rather large bump, the vibration amplitude of the body of the vehicle may be larger than a predetermined range of vibration amplitude, and thus may be considered to exceed the corresponding predetermined range.

With a plurality of impediment parameters, as long as any one of them has an amount of variation exceeding a predetermined range, it may be considered that the vehicle encounters a traffic impediment. In order to avoid a problem that a particular parameter may cause a high false alarm rate, two or more parameters may be considered in combination. For example, vibration amplitude and traveling speed of the vehicle may be considered in combination.

Because when a vehicle is traveling at a high speed, even a small rock may cause a considerable jarring of the body of the vehicle, and when the vehicle is traveling at a low speed, a rock of the same size may not cause a jarring of the body of the vehicle, the traveling speed and the vibration amplitude are closely related parameters. In an embodiment of the present disclosure, only when both the traveling speed is larger than a predetermined threshold and the vibration amplitude exceeds a corresponding predetermined range, may it be determined that the vehicle encounters a traffic impediment.

In step S105, when the amount of variation of the impediment parameter exceeds the corresponding predetermined range, the current location of the vehicle and the amount of variation of the impediment parameter are sent to a server.

When the current location of the vehicle is not an identified traffic impediment location, the server does not recognize that location as an identified traffic impediment location. If at the current location, the amount of variation of an impediment parameter exceeds the corresponding predetermined range, the amount of variation of the impediment parameter of the vehicle at the current location is not in an acceptable range of amount of variation of the parameter for the vehicle to be considered as traveling normally, and thus the vehicle may be considered to encounter a traffic impediment.

Because the current location was not recognized by the server as an identified traffic impediment location, the server did not send that location to the vehicle as an identified traffic impediment location. Therefore, the current location of the vehicle and the amount of variation the impediment parameter at the current location of the vehicle are sent to the server, for the server to update information about identified traffic impediment locations and record that current location as a traffic impediment location.

When the amount of variation of the impediment parameter does not exceed the predetermined range, e.g. when the amount of variation of the impediment parameter is within the predetermined range, the process moves to step S101.

In an embodiment of the present disclosure, before the navigation terminal sends the current location of the vehicle and the amount of variation of the impediment parameter to the server, the navigation terminal may output a voice inquiry or a textual inquiry, such as “Have you encountered a traffic impediment?”. In response, the driver may, for example, select “yes” or “no” on the navigation terminal, or reply with a voice answer of “yes” or “no”, or describe the traffic impediment, such as by stating that “There is a deep pit about half a meter ahead.” The navigation terminal may save the voice description of the traffic impediment from the driver, and obtain accurate information about the traffic impediment based upon the response selected by the driver or by recognizing the voice answer. After it is confirmed that the vehicle encounters a traffic impediment, the current location of the vehicle and the amount of amount of the impediment parameter are sent to the server.

In a present embodiment, when the current location of the vehicle is not an identified traffic impediment location, an amount of variation of an impediment parameter of the vehicle is monitored. When the amount of variation of the impediment parameter exceeds the predetermined range, then a traffic impediment exists at the current location, but the server did not inform the terminal that this location is an identified traffic impediment location because the server does not recognize this location as an identified traffic impediment location, in response the vehicle sends the current location and the amount of variation of the impediment parameter at the current location of the vehicle to the server, for the server to update data of identified traffic impediment locations to include the current location.

Through a method disclosed by a present embodiment, real-time information about traffic impediments on a road may be learned about based upon locations of the vehicle and amounts of variation of an impediment parameter of the vehicle, and the real-time information is sent to a server for the server to update information about identified traffic impediment locations, so the server may then send more accurate information about identified traffic impediment locations to vehicles.

A server might not continuously learn updated information about an identified traffic impediment location, for example after an identified traffic impediment location is repaired. Therefore, in an embodiment of the present disclosure, as shown in FIG. 1, a method also may include the following steps.

In step S106, when the current location of the vehicle is an identified traffic impediment location, an amount of variation of the impediment parameter is detected when the vehicle is in the current location.

In step S106, after the above step S102, when it is determined that the current location of the vehicle is an identified traffic impediment location, an impediment parameter is acquired through the on-board information system when the vehicle is in the current location. Acquiring an impediment parameter may be implemented in a manner similar to the above step S103, and may include acquiring an impediment parameter of the vehicle through the on-board information system and then acquiring an amount of variation of the impediment parameter.

In step S107, it is determined whether the amount of variation of the impediment parameter does not exceed the corresponding predetermined range.

Determining whether the amount of variation of the impediment parameter does not exceed the corresponding predetermined range, e.g. determining whether the amount of variation of the impediment parameter is within the corresponding predetermined range, may be implemented in a manner similar to the above step S104. When it is determined that the amount of variation of the impediment parameter is within the corresponding predetermined range, the process moves to step S108. When it is determined that the amount of variation of the impediment parameter exceeds the corresponding predetermined range, the process moves to step S101.

For example, as shown in FIG. 2, when the road surface on which the vehicle is traveling has a steep bump or dip, or the road surface is uneven, or the vehicle is rolling over an obstacle, a jarring of the vehicle may occur, causing a sudden increase of the vibration amplitude of the vehicle. For example, at a time 1 second before the vehicle is traveling at a current location L, the vibration amplitude of the vehicle may be 20, and when the vehicle is traveling at the current location L, the vibration amplitude may be 100. Then, it may be calculated that the amount of variation of the vibration amplitude of the vehicle is 80. Assuming that the predetermined range corresponding to the amount of variation of the vibration amplitude is [10, 20], the amount of variation of the vibration amplitude of the vehicle when the vehicle is at the current location L exceeds the predetermined range. The process moves to step S101, to acquire a current location of the traveling vehicle, and then may move to subsequent steps of the process.

In step S108, when the amount of variation of the impediment parameter does not exceed the corresponding predetermined range, the amount of variation of the impediment parameter and the current location of the vehicle are sent to the server.

When an identified traffic impediment location has been previously sent to the vehicle by the server, and the current location of the vehicle is the same as that identified traffic impediment location recorded in the server, the current location of the vehicle may be recognized by the server as a traffic impediment location. When the acquired amount of variation of the vibration amplitude of the vehicle at the moment the vehicle is at that location is then within the predetermined range, the amount of variation of the vibration amplitude of the vehicle at the current location may be considered as belonging to the acceptable range of the amount of variation of the parameter, and the vehicle may be considered to be traveling normally. Therefore, it may be considered that the traffic impediment has been cleared, and that the current location of the vehicle should not be identified as a traffic impediment location.

In this regard, the current location of the vehicle and the amount of variation of the impediment parameter at the current location of the vehicle are sent to the server, for the server to update the information about the identified traffic impediment locations.

In a present embodiment, a process in which the vehicle is arriving at an identified traffic impediment location is described. The vehicle acquires an identified traffic impediment location from the server. When the vehicle travels at that identified traffic impediment location, the amount of variation of the impediment parameter of the vehicle is monitored at that location. When the amount of variation of the impediment parameter monitored at that location exceeds the predetermined range, a traffic impediment is identified as still existing at that identified traffic impediment location. When the amount of variation of the impediment parameter monitored at that location does not exceed the predetermined range, and thus no traffic impediment now exists at that identified traffic impediment location, but the server is still identifying this location as a traffic impediment location, then the vehicle sends the current location and the amount of variation of the impediment parameter at this location to the server for the server to update the data of the traffic impediment locations, for example to indicate that the current location is not then an identified traffic impediment location.

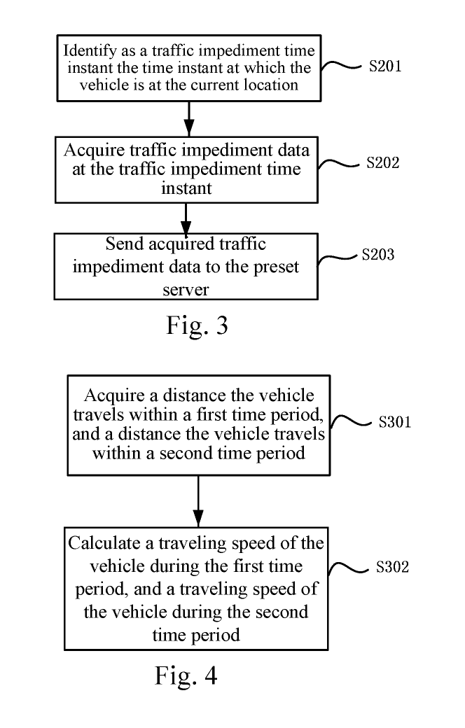

In above embodiments, when the vehicle encounters a traffic impediment, the vehicle may only send to the server the current location of the vehicle and the amount of variation of the impediment parameter at the current location of the vehicle. However, these might not be enough for a driver to clearly learn about the traffic impediment and the ambient environment. In this regard, in an embodiment of the present disclosure, as shown in FIG. 3, when the current location of the vehicle is not an identified traffic impediment location, and after the amount of variation of the impediment parameter exceeds the corresponding predetermined range, a method may also include the following steps.

In step S201, a time instant at which the vehicle is in the current location is identified as a traffic impediment time instant.

When the current location of the vehicle is not an identified traffic impediment location, the current location is considered as having a normal road condition by the server and the whole system. When the current location is not an identified traffic impediment, but it is determined that the amount of variation of the impediment parameter at the current location exceeds the corresponding predetermined range, the current location should then be recorded as an identified traffic impediment location.

For example, in step S201, the time instant at which the vehicle is in the current location is identified as a traffic impediment time instant. For example, a vehicle may be traveling through an intersection between Anding Road and North Tucheng East Road, Chaoyang District, Beijing and encounter a traffic impediment, at 10:10:40 a.m., Mar. 15, 2015. The location of the traffic impediment is acquired as: intersection between Anding Road and North Tucheng East Road, Chaoyang District, Beijing, and the time instant when the vehicle is traveling at the location of the traffic impediment is acquired as: 10:10:40 a.m., Mar. 15, 2015. A traffic impediment time instant may thus for example be identified in the form of a timestamp at a time instant a traffic impediment is encountered.

In step S202, traffic impediment data at the traffic impediment time instant is acquired, the traffic impediment data containing at least one of image data from within a first predetermined time period before the traffic impediment time instant or image data from within a second predetermined time period after the traffic impediment time instant.

The image data may include video data, picture data, etc. Nowadays, many vehicles are equipped with one or more video or image capture systems, such as tachographs and on-board radar systems. A tachograph may, for example, be configured to acquire a video in front of the vehicle, and an on-board radar system may be configured to acquire a video behind the vehicle in backward traveling. A navigation terminal may be connected to an access interface of a tachograph to acquire video data or image data in front of the vehicle at a predetermined time before and after the vehicle is traveling at a location of a traffic impediment. A navigation terminal may, for example, be connected to an access interface of an on-board radar system and configured to acquire video data or image data behind the vehicle when the vehicle is traveling backwards within a predetermined time period before and after the vehicle is traveling at a location of a traffic impediment. As an example, image data may be acquired from one or more frames of video data.

For example, when a vehicle is traveling forward and encounters a traffic impediment, video data or image data in front of the vehicle may be acquired through a tachograph from within a first predetermined time period, for example 10 seconds, before the traffic impediment time instant, and video data or image data in front of the vehicle may be acquired through the tachograph within a second predetermined time period, for example 5 seconds, after the traffic impediment time instant.

When the vehicle is traveling backward and encounters a traffic impediment, video data or image data behind the vehicle within a first predetermined time period, for example 10 seconds, before the traffic impediment time instant, and video data or image data behind the vehicle within a second predetermined time period, for example 5 seconds, after the traffic impediment time instant are acquired through an on-board radar system.

In step S203, the traffic impediment data is sent to the traffic data server.

In a present embodiment, image data before and after the vehicle is traveling at a location of a traffic impediment is sent to the traffic data server, for the server to both record an identified traffic impediment location and store video data or image data of the identified traffic impediment location.

Therefore, the specific nature of the traffic impediment location and the ambient environment of the traffic impediment location may be intuitively learned about through the video data of the traffic impediment location which is stored in the traffic data server.

Because an amount of variation of an impediment parameter such as vibration amplitude of the vehicle may be closely related to the traveling speed of the vehicle, when a vehicle is traveling at a high speed, a small unevenness of a road surface may significantly influence the amount of variation of the impediment parameter of the vehicle. In this regard, in an embodiment of the present disclosure, a traveling speed of the vehicle may also be acquired at the traffic impediment time instant which is acquired in step S201 in above embodiments. As shown in FIG. 4, the process of acquiring a traveling speed of the vehicle may include the following steps.

In step S301, a distance the vehicle travels within the first predetermined time period before the traffic impediment time instant is acquired, and a distance the vehicle travels within the second predetermined time period after the traffic impediment time instant is acquired.

For example, the traffic impediment time instant may be 10:10:40, and the first predetermined time period may be set as the 10 seconds before the traffic impediment time instant. Then, the starting point of the first predetermined time period is 10:10:30, and a traveling location of the vehicle at the starting point of the first predetermined time period is acquired, i.e. the traveling location of the vehicle at 10:10:30 is acquired. A linear distance between the traveling location of the vehicle at the starting point of the first predetermined time period and the traffic impediment location is calculated and taken as the distance the vehicle travels within the first predetermined time period.

Similarly, an endpoint of the second time period after the traffic impediment time instant is acquired, and the traveling location of the vehicle at the endpoint is acquired. Then, a linear distance between the traffic impediment location and the traveling location at the endpoint of the first predetermined time period is calculated and taken as the distance the vehicle travels within the second predetermined time period.

In step S302, based on the duration of the first predetermined time period and the distance the vehicle travels within the first predetermined time period, the traveling speed of the vehicle during the first predetermined time period is calculated, and based on the duration of the second predetermined time period and the distance the vehicle travels within the second predetermined time period, the traveling speed of the vehicle during the second predetermined time period is calculated. For example, a traveling speed may be calculated by dividing a distance traveled by a duration of the predetermined time period within which that distance was traveled.

Information about a traffic impediment may be acquired more accurately by acquiring traveling speeds of the vehicle before and after the identified traffic impediment location and combining them with the amount of variation of the impediment parameter of the vehicle. For example, when the vehicle is traveling at a high speed, even a small bump in a road surface (such as a speed bump) may cause a significant jarring of the vehicle such that the amount of variation of the vibration amplitude of the vehicle increases dramatically and exceeds the predetermined range corresponding to the amount of variation of the vibration amplitude of the vehicle.

When the vehicle is traveling at a low speed, the same speed bump may not cause jarring of the vehicle, and the amount of variation of the vibration amplitude of the vehicle may increase by a small quantity, and probably will not exceed the predetermined range corresponding to the amount of variation of the vibration amplitude of the vehicle. Thus, contextual information about the traffic impediment may be acquired more accurately by acquiring traveling speeds of the vehicle before and after the predetermined traffic impediment time instant.

In a present embodiment, a traveling speed of the vehicle at a traffic impediment location is acquired to further learn about the degree to which the traffic impediment affects normal travel of the vehicle. Therefore, contextual information about the traffic impediment may be accurately acquired based upon a combination of traveling speeds of the vehicle before and after the vehicle is at the traffic impediment location and motion parameters of the vehicle.

A vehicle sometimes travels on a non-road surface on which may exist objects, such as steps, that may cause jarring to the vehicle. When a vehicle travels on an uneven non-road surface, the amount of variation of the impediment parameter of the vehicle will probably exceed the predetermined range. If the current location of the vehicle on a non-road surface is sent to the traffic data server, the traffic data server might normally record the current location as a traffic impediment location.

However, when the traffic impediment location is on a non-road surface, storing that location as a traffic impediment location in the traffic data server may be not be helpful for the purpose of alerting drivers to traffic impediments. In this regard, in an embodiment, the traffic data server would generally not record as a traffic impediment location a traffic impediment at a location on a non-road surface. In an embodiment of the present disclosure, before the above step S102 (i.e. before it is determined whether the current location of the vehicle is an identified traffic impediment location), a method as shown in FIG. 5 may also include the following steps.

In step S401, it is determined whether the current location of the vehicle is on a road.

The traffic data server may contain information about all roads, including latitude and longitude coordinates of locations of the roads. Latitude and longitude coordinates of the roads may be respective coordinate points which define respective coordinate ranges of respective roads.

The current location of the vehicle is sent to the traffic data server. The traffic data server determines whether latitude and longitude coordinates of the current location of the vehicle are within a coordinate range of a road. When the latitude and longitude coordinates of the current location of the vehicle are within a coordinate range of a road, the traffic data server sends to the navigation terminal of the vehicle a message that it is determined that the current location is on a road, and the navigation terminal of the vehicle may determine that the current location of the vehicle is on a road based on the message. If the latitude and longitude coordinates of the current location of the vehicle do not belong to a coordinate range of a road, the traffic data server sends to the navigation terminal of the vehicle a message that it is determined that the current location is on a non-road surface, and the navigation terminal of the vehicle may determine that the current location of the vehicle is on a non-road surface based on the message.

Alternatively, the navigation terminal downloads information about all of the roads in advance, and it may determine whether the current location of the vehicle is on a road through the above process.

When the current location of the vehicle is on a road, it may be determined that the traffic impediment location is on a road surface, and the process moves to step S102. When the current location of the vehicle is not on a road (for example, the vehicle may be traveling on a side pavement or traveling on a floor with steps), the amount of variation of the impediment parameter of the vehicle will probably exceed the corresponding predetermined range. In this case, the current location of the vehicle would not be considered as a traffic impediment location. Therefore, the process moves to step S101, to again acquire a current location of the traveling vehicle.

In a present embodiment, by confirming whether a traffic impediment location is on a road, a method may avoid a situation where a non-road location is erroneously considered to be a traffic impediment location on a road because of the influence of the non-road surface on the amount of variation of the impediment parameter, and it may thus ensure validity and accuracy of the information about the traffic impediment location received by the traffic data server.

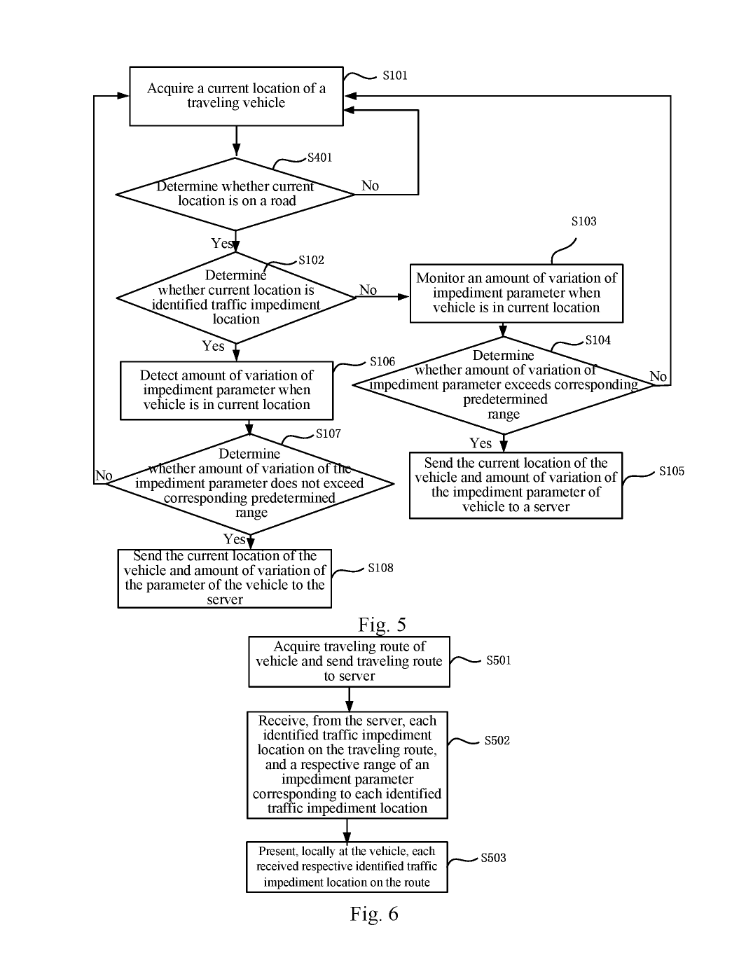

In above embodiments, the vehicle may acquire an identified traffic impediment location from the traffic data server. However, because the traffic data server may not know about the traveling route of the vehicle, the server might send to the vehicle all of the identified traffic impediment locations within a range of locations around the location of the vehicle. In this regard, in an embodiment of the present disclosure, as shown in FIG. 6, a method may also include the following steps.

In step S501, a traveling route of the vehicle is acquired and the traveling route is sent to the traffic data server.

When the user sets a destination of the vehicle with the navigation terminal, the navigation terminal will plan and generate a traveling route for the vehicle based upon the current location of the vehicle and the set destination of the vehicle. For example, assuming that the current location of the user is Peking University, and the destination is China Agricultural University, the navigation terminal may plan for the user a traveling route from Peking University to China Agricultural University, which starts from Peking University, travels some particular roads, and arrives at China Agricultural University. That traveling route may be displayed as being superimposed on the map on the navigation terminal.

The traveling route is sent to the traffic data server. The sent traveling route may be in a form of latitude and longitude coordinates of a plurality of coordinate points on the traveling route, such that the traffic data server may further generate the same planned traveling route based on these sent latitude and longitude coordinates or may perform other operations directly with these sent latitude and longitude coordinates, for example, determining whether an identified traffic impediment location which is stored in the traffic data server is on the traveling route.

In step S502, each identified traffic impediment location on the traveling route, and a respective predetermined range of an impediment parameter corresponding to each of the identified traffic impediment locations on the traveling route, are received from a traffic data server.

After the traffic data server receives the traveling route from the vehicle, the server may determine whether a stored identified traffic impediment location is on the traveling route, and may send to the vehicle all of the identified traffic impediment locations on the traveling route, and a respective predetermined range of an impediment parameter corresponding to each of the identified traffic impediment locations on the traveling route, such that the amount of variation of the impediment parameter may be compared with the predetermined range.

In step S503, each received respective identified traffic impediment location on the traveling route is presented locally at the vehicle.

When the vehicle receives an identified traffic impediment location and an amount of variation of the impediment parameter, the received information may be presented locally at the vehicle, for example in a form of voice broadcast such that the driver may preemptively respond to the identified traffic impediment location based on the information sent from the terminal. For example, before approaching an identified traffic impediment location of which the driver has been alerted to beforehand by the vehicle, the driver may slow down or bypass it.

In a present embodiment, the traveling route of the vehicle is acquired and the traveling route is sent to the traffic data server, so that identified traffic impediment locations on that traveling route may be received from the traffic data server. In this way, the traffic data server may send identified traffic impediment locations and other related information to the vehicle that the driver may use them to effectively respond to traffic impediment at those locations.

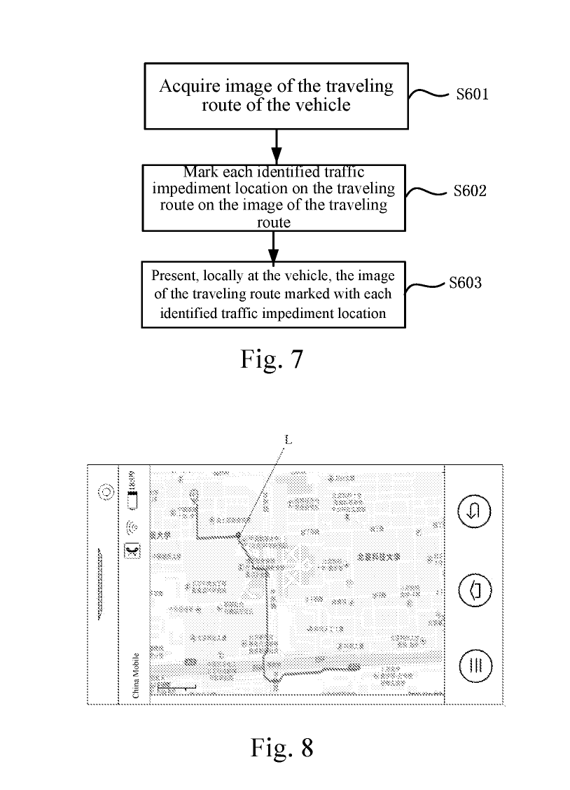

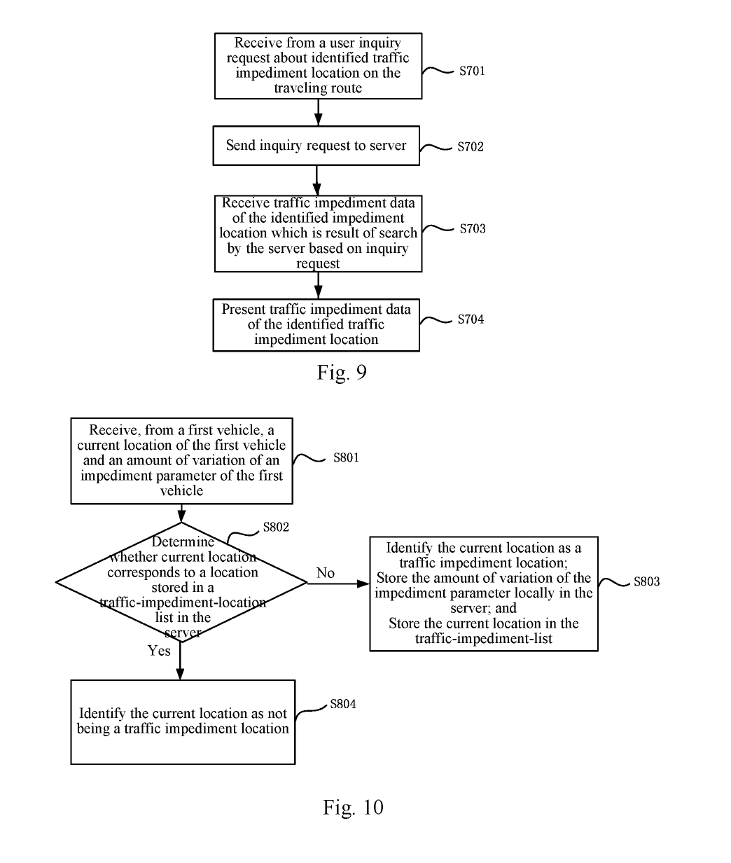

In the above step S503, when the vehicle receives an identified traffic impediment location and an amount of variation of the impediment parameter, the identified traffic impediment location may also be directly presented at the vehicle through the display screen of the terminal. In an embodiment of the present disclosure, as shown in FIG. 7, a method may include the following steps.

In step S601, an image of the traveling route of the vehicle is acquired.

Based upon the traveling route of the vehicle acquired in the above step S502, the traveling route and images of the traveling route in the navigation terminal are acquired. The images of the traveling route may be stored in the navigation terminal in advance, or may be downloaded from the traffic data server, and may include information such as images of roads and ambient buildings on or near the traveling route. As the vehicle travels, the images of the traveling route may be updated, such that the driver may view images of the traveling route that always correspond to the current location of the vehicle, the current road the vehicle is on, and the current ambient environment of the vehicle.

In step S602, each identified traffic impediment location on the traveling route is marked on the image of the traveling route.

As shown in FIG. 8, after an identified traffic impediment location L is acquired, the identified traffic impediment location L is directly marked on the traveling route according to the latitude and longitude coordinates of the identified traffic impediment location L and highlighted on the image of the traveling route with an indicator bubble or an indicator pattern.

In step S603, the image of the traveling route marked with each identified traffic impediment location is presented locally at the vehicle.

The traveling route marked with the identified traffic impediment locations is displayed on the display screen of the navigation terminal. As the vehicle approaches an identified traffic impediment location, the navigation terminal will issue a voice warning. In addition, when the vehicle is at a current location sufficiently close to an identified traffic impediment location, information about the identified traffic impediment location may be displayed on the display screen of the navigation terminal so the information may be directly observed on the traveling route, to prompt the driver to take actions in advance of reaching the traffic impediment.

In above embodiments, although the vehicle may acquire an identified traffic impediment location, the vehicle might not learn in advance about the nature and context of the situation and the ambient environment of the traffic impediment. Therefore, the driver might only be able to select to either proceed or bypass the location, and might not make a precise judgment based upon the particular nature of the traffic impediment, which may not be ideal. In this regard, in an embodiment of the present disclosure, as shown in FIG. 8, a method may also include the following steps.

In step S701, an inquiry request inquiring about an identified traffic impediment location on the traveling route is received from a user.

After the navigation terminal of the vehicle receives a from the traffic data server an identified traffic impediment location which is sent by the traffic data server based upon the traveling route of the vehicle, the user may set an identified traffic impediment location on the traveling route as a selected identified traffic impediment location, and an inquiring operation may be performed on the selected identified traffic impediment location.

For example, the user may click to select an identified traffic impediment location on the display screen of the navigation terminal. At this time, the navigation terminal may prompt the user as to whether the user wants to inquire about more information about the selected identified traffic impediment location. If the user selects to view more information, an inquiring operation is triggered to issue an inquiry request.

In step S702, the inquiry request is sent to the traffic data server

The inquiry request in step S701 is sent to the traffic data server. Based upon the inquiry request, the traffic data server finds a locally stored record which corresponds to the identified traffic impediment location, and inquires about traffic impediment data about the identified traffic impediment location. The traffic impediment data may include video data, image data, audio data, and the like, at or associated with the identified traffic impediment location.

The traffic data server sends the resulting information to the navigation terminal, which issues the inquiry request.

In step S703, traffic impediment data of the identified traffic impediment location which is searched for by the traffic data server based on the inquiry request is received.

In above embodiments, when the vehicle encounters a traffic impediment, and the traffic impediment is not recorded in the traffic data server, the traffic impediment is considered a newly found traffic impediment or a traffic impediment which has not been encountered by any other vehicle. Thus the vehicle sends the traffic impediment location to the traffic data server and sends the video data or image data of the traffic impediment acquired by the vehicle to the traffic data server.

After another vehicle issues to the traffic data server an inquiry request for inquiring about traffic impediment data of an identified traffic impediment location, the vehicle may receive an inquiry result from the traffic data server. The inquiry result is traffic impediment data of the traffic impediment location and may include one or more of video data or image data of the traffic impediment, a traveling speed of a vehicle at the identified traffic impediment location (for example as acquired in above embodiments), or a voice notice provided by a driver to the traffic data server.

In step S704, the traffic impediment data of the identified traffic impediment location is presented.

After the vehicle receives the traffic impediment data of the identified traffic impediment location, the traffic impediment data of the identified traffic impediment location may be presented on the display screen of the terminal. For example, the video data or the image data of the traffic impediment is played, the voice message is broadcast, or a text message is displayed, etc. The traffic impediment data of the identified traffic impediment location may be presented manually by the user or automatically by the terminal.

In a present embodiment, because traffic impediment data of an identified traffic impediment location is sent to a vehicle, the driver may clearly acquire practical information about the traffic impediment he will encounter at that location. Thereby, the driver may make an accurate judgment about the traffic impediment and may timely modify the traveling route or slow down, or otherwise appropriately respond.

In above embodiments, a method is described for processing traffic data which is applied in a vehicle. Generally, there may be two aspects of the method. In one aspect, information about a new traffic impediment is sent to the traffic data server. For example, a vehicle is traveling on a road, travels through a traffic impediment location which is not recorded in a traffic data server, and an amount of variation of an impediment parameter exceeds a predetermined range. Thus the current location of the vehicle, i.e. the location of the traffic impediment, the amount of variation of the impediment parameter of the vehicle at the current location, and various other traffic impediment data related to the location of the traffic impediment are sent to the traffic data server. Thus other vehicles may learn about the location of the traffic impediment and practical information about the location of the traffic impediment before they travel to the location.

In another situation, information about previously identified traffic impediment locations is sent to the traffic data server so the traffic data server records accurate information about previously identified traffic impediment location. For example, a vehicle is traveling on a road, and acquires in advance information about a traffic impediment location that exists on its traveling route. Then, when the vehicle is travelling at the traffic impediment location, it is detected whether an amount of variation of an impediment parameter of the vehicle at the traffic impediment location exceeds a predetermined range. If the amount of variation of the impediment variable exceeds the predetermined range, a traffic impediment that will influence a vehicle still exists at that location, and the traffic impediment location is automatically kept as an identified traffic impediment location. When the amount of variation of the impediment parameter does not exceed the predetermined range, a traffic impediment that would influence a vehicle is no longer present at that location, and the former traffic impediment location and the amount of variation of the impediment parameter of the vehicle at the former traffic impediment location are sent to the traffic data server, for the server to learn that the former traffic impediment has been cleared. When other vehicles pass this location, the server will not send them information that this location is an identified traffic impediment location.

FIG. 10 is a flow chart illustrating a method for processing traffic data according to still another exemplary embodiment, which is applied in a traffic data server. As shown in FIG. 10, a method may include the following steps.

In step S801, a current location and an amount of variation of an impediment parameter are received from the first vehicle.

As described in above embodiments, the first vehicle will send to the traffic data server a current location of the first vehicle and an amount of variation of an impediment parameter of the first vehicle, and the traffic data server receives these data from the first vehicle.

In step S802, it is determined whether the current location corresponds to a location previously stored in a traffic-impediment-location list in the traffic data server.

The traffic data server may locally store traffic impediment locations and vehicle data of the first vehicle when the first vehicle is at the traffic impediment locations. These data are previously acquired data or may be data previously acquired by other terminals. For example, as described in above embodiments, when the first vehicle travels to a traffic impediment location that is not recorded as an identified traffic impediment location in the traffic data server, the new traffic impediment location is sent to the traffic data server for the traffic data server to locally store the new traffic impediment location as an identified traffic impediment location. The traffic data server may locally store a traffic-impediment-location list that contains all of the traffic impediment locations stored by the traffic data server and access paths of related data corresponding to each of the traffic impediment locations.

When the traffic data server receives from the first vehicle the current location and the vehicle data when the first vehicle is at the location, the traffic data server may compare the current location of the first vehicle with each traffic impediment location in the traffic-impediment-location list locally stored in the traffic data server, and determine whether the current location sent from the terminal corresponds to a traffic impediment location in the traffic-impediment-location list.

A current location may correspond to a traffic impediment location when the two locations are the same, or when a distance between the two locations is within a predetermined range. For example, the traffic-impediment-location list may contain a traffic impediment location which is at a southeast corner of an intersection of road A and road B, and the traffic impediment location sent by the first vehicle to the traffic data server may be 1 meter south of the southeast corner of an intersection of road A and road B, and thus it may be considered that the two locations correspond to each other.

In step S803, when the current location does not correspond to a location previously stored in the traffic-impediment-location list in the traffic data server, the current location is identified as a traffic impediment location, the amount of variation of the impediment parameter is stored locally in the traffic data server, and the current location is stored in the traffic-impediment-location list.

When the current location sent by the first vehicle does not correspond to a location previously stored in the traffic-impediment-location list locally in the traffic data server, the current location sent by the first vehicle may be marked as a traffic impediment location and stored in the traffic-impediment-location list locally in the traffic data server. The amount of variation of the impediment parameter may be locally stored in the traffic data server. When the first vehicle sends other traffic impediment data related to this location, the traffic impediment data may be locally stored in the traffic data server as well.

A respective traffic impediment location is stored as corresponding to the respective related traffic impediment data, such that when the respective traffic impediment location is acquired, all of the respective traffic impediment data related to that respective traffic impediment location may be directly acquired.

In an embodiment, a method for processing traffic data also may include: sending the current location as an identified traffic impediment location to a second vehicle.

When the second vehicle sends a traveling route to the traffic data server, the current location sent by the first vehicle is sent to the second vehicle as an identified traffic impediment location.

In a present embodiment, the traffic data server receives from a vehicle the current location of the vehicle and the amount of variation of the impediment parameter of the vehicle at the current location, and compares the current location sent by the vehicle with the traffic-impediment-location list in the traffic data server. When the current location sent by the vehicle corresponds to a location previously stored in the traffic-impediment-location list stored locally in the traffic data server, the server updates the data related to the previously stored corresponding traffic impediment in the traffic data server with the data related to the traffic impediment that is sent by the vehicle and that is related to the traffic impediment.

If the current location sent by the vehicle does not correspond to a location previously stored in the traffic-impediment-location list stored locally in the traffic data server, the data that is sent by the vehicle and that is related to the traffic impediment is stored locally in the traffic data server as new data. Data related to a traffic impediment that is stored locally in the server may be sent to a vehicle on a traveling route on which the traffic impediment exists.

A present embodiment may acquire most recent information about traffic impediments in real time, and information about traffic impediments may be updated in real time. Thus, a present embodiment may ensure the accuracy of identified traffic impediment locations and other related data stored in the traffic data server, and thus it may ensure the accuracy of the information sent by the traffic data server to vehicles.

In an embodiment of the present disclosure, as shown in FIG. 10, a method may also include the following steps.

In step S804, when the current location corresponds to a location previously stored in the traffic-impediment-location list, the location in the traffic-impediment-location list which corresponds to the current location is identified a not being a traffic impediment location.

When the current location corresponds to a location previously stored in the traffic-impediment-location list locally in the traffic data server, the current location of the first vehicle which sends information to the traffic data server is a traffic impediment location that is already recorded in the traffic data server. The first vehicle only sends its current location and amount of variation of the impediment parameter from a traffic impediment location already recorded in the server when the amount of variation of the impediment parameter of the first vehicle at the location is within the predetermined range, i.e. when the first vehicle does not encounter a traffic impediment at this location. Therefore, when it may be determined that the current location sent by the first vehicle corresponds to a location previously stored in a traffic-impediment-location list stored locally in the traffic data server, it may also be determined that the traffic impediment formerly at that traffic impediment location has likely been cleared.

Therefore, the traffic data server may identify as not being a traffic impediment location the location in the traffic-impediment-location list stored locally in the traffic data server which corresponds to the current location, and store the current location and the amount of variation of the impediment parameter at the current location which are sent by the first vehicle and other related data. When a location identified as not being a traffic impediment location exists in the traffic data server, the traffic data server may delete all data related to that location, thereby saving storage resources of the traffic data server.

For example, the traffic-impediment-location list stored locally in the traffic data server may contain an identified traffic impediment location that is a southeast corner of an intersection of a road A and a road B, and the acquired amount of variation of vibration amplitude of the vehicle at the traffic impediment location may be 50. The current location sent by the vehicle to the traffic data server may be 1 meter south of the southeast corner of the intersection of the road A and the road B, the acquired amount of variation of vibration amplitude of the vehicle at the location may be 10, and the predetermined range of the amount of variation of vibration amplitude of the vehicle may be [10, 20].

Thus, it may be seen that in that example, the amount of variation of vibration amplitude of the vehicle at the location does not exceed, i.e. is within, the predetermined range. The current location and the amount of variation of vibration amplitude of the vehicle at the location and other data which are sent by the vehicle are stored by the traffic data server. Thus, the information about the identified traffic impediment location previously stored in the traffic data server is updated.

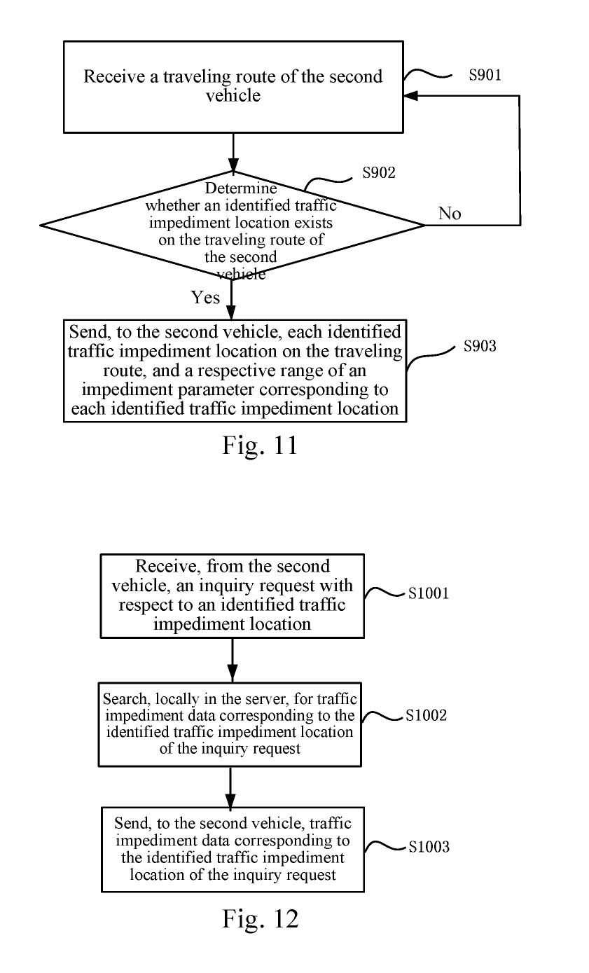

In above embodiments, the traffic data server may send data related to a traffic impediment to a second vehicle. However, a traffic data server might not necessarily know which related data of the traffic impediment should be sent to the second vehicle. In this regard, in another embodiment of the present disclosure, as shown in FIG. 11, a method may also include the following steps.

In step S901, a traveling route of the second vehicle is received.

After a second vehicle acquires a traveling route of the second vehicle, for example by above embodiments which may include step S501, and sends the traveling route to the traffic data server, for example by above embodiments which may include step S501, the traffic data server receives the traveling route sent by the second vehicle.

In step S902, it is determined whether an identified traffic impediment location exists on the traveling route of the second vehicle.

After the traffic data server receives the traveling route sent by the second vehicle, the traffic data server may compare the traveling route with each of the traffic impediment locations stored in the traffic-impediment-location list in the traffic data server. As described in above embodiments, for example by a process that may include step S502, when a traffic impediment location exists on the traveling route, that is, when a traffic impediment location is crossed by the traveling route, it may be determined that the traveling route of the second vehicle contains an identified traffic impediment location.

In step S903, when an identified traffic impediment location exists on the traveling route of the second vehicle, each identified traffic impediment location on the traveling route, and a respective predetermined range of an impediment parameter corresponding to each of the identified traffic impediment locations, are sent to the second vehicle.

If an identified traffic impediment location exists on the traveling route, the traffic data server locally acquires a predetermined range of an impediment parameter corresponding to the identified traffic impediment location and other data related to the identified traffic impediment location. Moreover, these data are sent to the second vehicle, for the second vehicle to prompt the driver according to the acquired identified traffic impediment locations and other data such that the driver may response before he travels to the identified traffic impediment location.

In a present embodiment, a traveling route of a second vehicle is received, and it is determined whether an identified traffic impediment location exists ahead of the second vehicle based on the traveling route. When it is determined that an identified traffic impediment location exists ahead of the second vehicle, the identified traffic impediment location and other related data are sent to the second vehicle, so the driver may preemptively respond before he travels to the identified traffic impediment location, such as by avoiding the traffic impediment location or lowering his traveling speed.

In above embodiments, the vehicle acquires traffic impediment data and sends it to the server. Therefore, in an embodiment of the present disclosure, a method may also include the following steps.

Traffic impediment data sent from the first vehicle is received, and the traffic impediment data contains at least image data of the traffic impediment location. For example, the first vehicle may acquire traffic impediment data when the first vehicle is at the identified traffic impediment location. The traffic impediment data may include at least image data of the traffic impediment location, and may also include the traveling speed when the first vehicle is at the identified traffic impediment location, and a voice notice of a driver regarding the identified traffic impediment location. The first vehicle sends these traffic impediment data to the server, and the server receives these traffic impediment data.

Received traffic impediment data is stored locally in the server and is sent to a second vehicle. The server stores received traffic impediment data locally in the server, and stores respective traffic impediment data as corresponding to a respective identified traffic impediment location. When a second vehicle requests the respective traffic impediment data of the respective identified traffic impediment location, the respective traffic impediment data may be sent to the second vehicle.

In above embodiments, the vehicle may send an inquiry request to the server. Therefore, in an embodiment of the present disclosure, a method may also include the following steps, as shown in FIG. 12.

In step S1001, an inquiry request with respect to an identified traffic impediment location is received from the second vehicle.

The inquiry request may include the identified traffic impediment location, and when the traffic data server receives the inquiry request from the second vehicle, and the process moves to step S1002.

In step S1002, traffic impediment data corresponding to the identified traffic impediment location of the inquiry request is searched for locally in the traffic data server.

For example, after the traffic data server receives the inquiry request which includes the identified traffic impediment location, the traffic data server may search the traffic-impediment-location list for a traffic impediment location record corresponding to the identified traffic impediment location. In addition, the traffic data server may locally search for traffic impediment data corresponding to the identified traffic impediment location.

In step S1003, traffic impediment data corresponding to the identified traffic impediment location of the inquiry request is sent to the second vehicle.

In embodiments of the present disclosure, the first vehicle and the second vehicle may be the same vehicle, for example, when a vehicle travels through the same location at two different times.

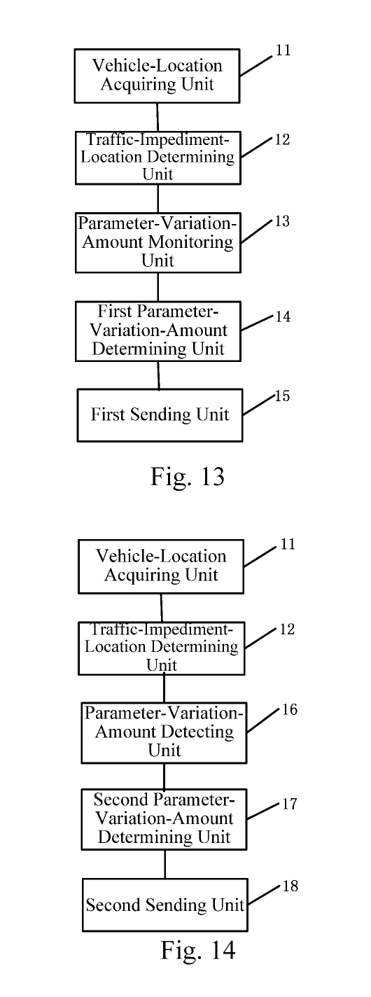

FIG. 13 is a block diagram of a device for processing traffic data according to an exemplary embodiment. As shown in FIG. 13, a device may include: a vehicle-location acquiring unit 11, a traffic-impediment-location determining unit 12, a parameter-variation-amount monitoring unit 13, a first parameter-variation-amount determining unit 14 and a first sending unit 15.

The vehicle-location acquiring unit 11 is configured to acquire a current location of a traveling vehicle.

The traffic-impediment-location determining unit 12 is configured to determine whether the current location is an identified traffic impediment location.

The parameter-variation-amount monitoring unit 13 is configured to, when the current location is not an identified traffic impediment location, monitor an amount of variation of an impediment parameter when the vehicle is in the current location.

The first parameter-variation-amount determining unit 14 is configured to determine whether the amount of variation of the impediment parameter exceeds a corresponding predetermined range.

The first sending unit 15 is configured to, when the amount of variation of the impediment parameter exceeds the predetermined range, send the current location and the amount of variation of the impediment parameter to a traffic data server.

In an embodiment of the present disclosure, a device further may include: a traffic-impediment-time-instant acquiring unit, a traffic-impediment-data acquiring unit and a traffic-impediment-data sending unit.

The traffic-impediment-time-instant acquiring unit is configured to, when the current location is not an identified traffic impediment location and the amount of variation of the impediment parameter exceeds the corresponding predetermined range, identify a time instant at which the vehicle is in the current location as a traffic impediment time instant.

The traffic-impediment-data acquiring unit is configured to acquire traffic impediment data at the traffic impediment time instant, the traffic impediment data containing one or more of image data from within a first predetermined time period before the traffic impediment time instant or image data from within a second predetermined time period after the traffic impediment time instant.

The traffic-impediment-data sending unit is configured to send the traffic impediment data to the traffic data server.

In an embodiment of the present disclosure, as shown in FIG. 14, a device may further include: a parameter-variation-amount detecting unit 16, a second parameter-variation-amount determining unit 17 and a sending unit 18.

The parameter-variation-amount detecting unit 16, connected with the traffic-impediment-location determining unit 12, is configured to, when the current location is an identified traffic impediment location, detect an amount of variation of an impediment parameter when the vehicle is in the current location.

The second parameter-variation-amount determining unit 17 is configured to detect whether the amount of variation of the impediment parameter is within the corresponding predetermined range.

The second sending unit 18 is configured to, when the amount of variation of the impediment parameter is within the corresponding predetermined range, send the amount of variation of the impediment parameter and the current location to the traffic data server.

In an embodiment of the present disclosure, a device may further include: a traveling-route acquiring unit, a traffic-impediment-location receiving unit and a presenting unit.

The traveling-route acquiring unit is configured to acquire a traveling route of the vehicle and send the traveling route to the traffic data server.

The traffic-impediment-location receiving unit is configured to receive, from the traffic data server, identified traffic impediment locations on the traveling route, and a respective predetermined range of an impediment parameter corresponding to each of the identified traffic impediment locations on the traveling route.

The presenting unit is configured to present, locally at the vehicle, each received identified traffic impediment location on the traveling route.

In an embodiment of the present disclosure, a presenting unit may further include: a traveling-route acquiring sub-unit, a traveling-route marking sub-unit and a traveling-route presenting sub-unit.

The traveling-route acquiring sub-unit is configured to acquire the traveling route of the vehicle.

The traveling-route marking sub-unit is configured to mark on the traveling route, each identified traffic impediment location on the traveling route.

The traveling-route presenting sub-unit is configured to present, locally at the vehicle, the traveling route marked with the identified traffic impediment locations.

In an embodiment of the present disclosure, a device may further include: a traffic impediment inquiring unit, an inquiry-request sending unit, a traffic-impediment-data receiving unit and a traffic-impediment-data presenting unit.

The traffic impediment inquiring unit is configured to receive from a user an inquiry request inquiring about an identified traffic impediment location on the traveling route.

The inquiry-request sending unit is configured to send the inquiry request to the traffic data server.

The traffic-impediment-data receiving unit is configured to receive traffic impediment data of the identified traffic impediment location which is a result of a search by the traffic data server based on the inquiry request.

The traffic-impediment-data presenting unit is configured to present the traffic impediment data of the identified traffic impediment location.

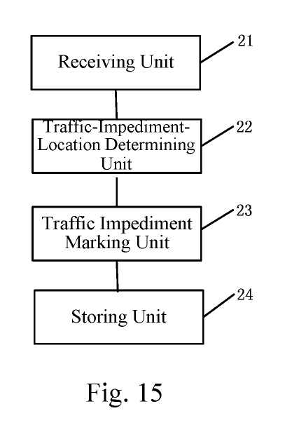

FIG. 15 is a block diagram of a server according to an exemplary embodiment. As shown in FIG. 15, a server may include: a receiving unit 21, a traffic-impediment-location determining unit 22, a traffic impediment marking unit 23 and a storing unit 24.

The receiving unit 21 is configured to receive, from a first vehicle, a current location of the first vehicle and an amount of variation of an impediment parameter of the first vehicle from the first vehicle.

The traffic-impediment-location determining unit 22 is configured to determine whether the current location corresponds to a location previously stored in a traffic-impediment-location list in the server.

The traffic impediment marking unit 23 is configured to, when the current location does not correspond to a location previously stored in the traffic-impediment-location list, identify the current location as a traffic impediment location.

The storing unit 24 is configured to store the amount of variation of the impediment parameter locally in the server, and store the current location in the traffic-impediment-location list. In an embodiment, a server may further include a sending unit, wherein the sending unit is configured to send as an identified traffic impediment location, to the second vehicle, the current location.

In an embodiment of the present disclosure, a server may further include: a no-traffic-impediment-location marking unit.

The no-traffic-impediment-location marking unit is configured to, when the current location corresponds to a location previously stored in the traffic-impediment-location list, identify as not being a traffic impediment location the traffic-impediment-location in the traffic-impediment-location list which corresponds to the current location.

In an embodiment of the present disclosure, a server may further include: a traveling-route receiving unit, a traffic-impediment-location determining unit and a traffic-impediment-location sending unit.

The traveling-route receiving unit is configured to receive a traveling route sent from a second vehicle.

The traffic-impediment-location determining unit is configured to determine whether an identified traffic impediment location exists on the traveling route.

The traffic-impediment-location sending unit is configured to, when an identified traffic impediment location exists on the traveling route, send to the second vehicle identified traffic impediment locations on the traveling route, and a respective predetermined range of an impediment parameter corresponding to each of the identified traffic impediment locations on the traveling route.

In an embodiment of the present disclosure, a server may further include: a traffic-impediment-data receiving unit and a traffic-impediment-data storing unit.

The traffic-impediment-data receiving unit is configured to, when the current location is identified as a traffic impediment location, receive traffic impediment data of the traffic impediment location from the first vehicle, the traffic impediment data containing at least image data of the traffic impediment location.

The traffic-impediment-data storing unit is configured to store the traffic impediment data locally in the server.

In an embodiment of the present disclosure, a server may further include: an inquiry-request receiving unit, a traffic-impediment-data searching unit, and a traffic-impediment-data sending unit.

The inquiry-request receiving unit is configured to receive, from a second vehicle, an inquiry request with respect to an identified traffic impediment location.

The traffic-impediment-data searching unit is configured to search, locally in the server, for traffic impediment data corresponding to the identified traffic impediment location.

The traffic-impediment-data sending unit is configured to send, to the second vehicle, the traffic impediment data corresponding to the identified traffic impediment location.

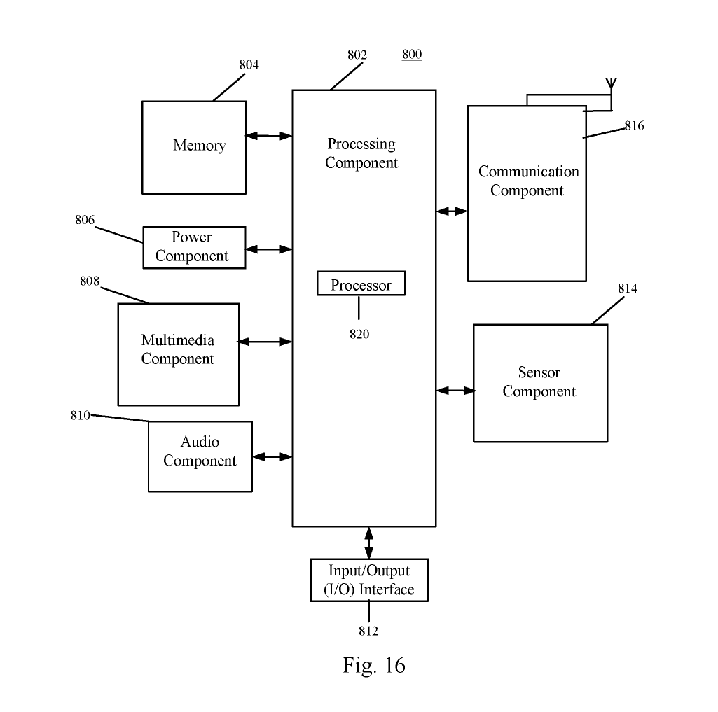

FIG. 16 is a block diagram of a terminal 800 according to an exemplary embodiment. For example, the terminal may be a mobile phone, a computer, a digital broadcast terminal, a messaging device, a gaming console, a tablet, a medical device, exercise equipment, a personal digital assistant, and the like.

Referring to FIG. 16, the mobile terminal may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the mobile terminal, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802. Processing component 802 may include any or all of the units associated above with FIGS. 13 and 14.

Each unit discussed above in connection with devices of FIGS. 13 and 14, such as, but not limited to, the vehicle-location acquiring unit 11, traffic-impediment-location determining unit 12, parameter-variation-amount monitoring unit 13, first parameter-variation-amount determining unit 14, first sending unit 15, parameter-variation-amount detecting unit 16, second parameter-variation-amount determining unit 17, and sending unit 18, may take the form of a packaged functional hardware unit designed for use with other components, a portion of a program code (e.g., software or firmware) executable by the processor 820 or the processing circuitry that usually performs a particular function or related functions, or a self-contained hardware or software component that interfaces with a larger system, for example.

The memory 804 is configured to store various types of data to support the operation of the mobile terminal. Examples of such data include instructions for any applications or methods operated on the mobile terminal, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the mobile terminal. The power component 806 may include a power management system, one or more power sources, and any other components associated with the generation, management, and distribution of power in the mobile terminal.

The multimedia component 808 includes a screen providing an output interface between the mobile terminal and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the mobile terminal is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the mobile terminal is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the mobile terminal. For instance, the sensor component 814 may detect an open/closed status of the mobile terminal, relative positioning of components, e.g., the display and the keypad, of the mobile terminal, a change in position of the mobile terminal or a component of the mobile terminal, a presence or absence of user contact with the mobile terminal, an orientation or an acceleration/deceleration of the mobile terminal, and a change in temperature of the mobile terminal. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the mobile terminal and other devices. The mobile terminal can access a wireless network based on a communication standard, such as WiFi, 2G or 3G or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the mobile terminal may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 804, executable by the processor 820 in the mobile terminal, for performing the above-described methods. For example, the non-transitory computer-readable storage medium may be a ROM, a RAM, a CD-ROM, a magnetic tape, a floppy disc, an optical data storage device, and the like.

A non-transitory computer readable storage medium may be provided, the storage medium storing instructions which executed by the processor of the terminal, cause the terminal to perform a method for processing traffic data. Execution of the instructions may cause the terminal to acquire a current location of a traveling vehicle. Execution of the instructions may further cause the terminal to determine whether the current location of the vehicle is an identified traffic impediment location. Execution of the instructions may further cause the terminal to when the current location of the vehicle is not an identified traffic impediment location, monitor an amount of variation of an impediment parameter when the vehicle is in the current location. Execution of the instructions may further cause the terminal to when the current location of the vehicle is not an identified traffic impediment location, determine whether the amount of variation of the impediment parameter exceeds a corresponding predetermined range. Execution of the instructions may further cause the terminal to, when the amount of variation of the impediment parameter exceeds the predetermined range, sending the current location and the amount of variation of the impediment parameter to a traffic data server. Execution of the instructions may further cause the terminal to perform any other operation indicated as being performed by a terminal throughout this disclosure.

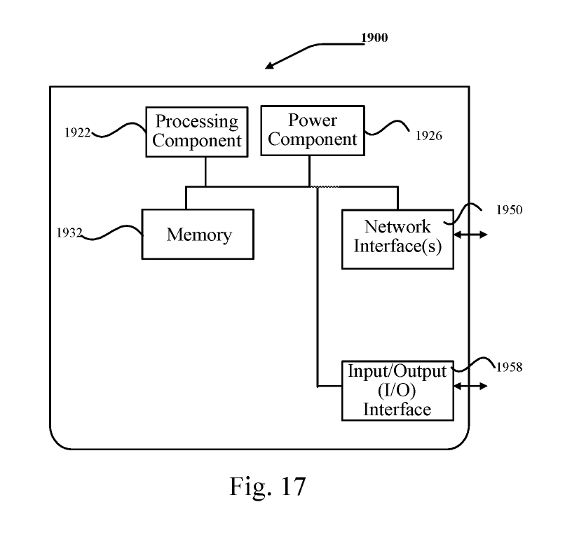

FIG. 17 is a block diagram of a traffic data server 1900 according to an exemplary embodiment. For example, the server 1900 may be provided as a server. Referring to FIG. 17, the server 1900 includes a processing component 1922 that further includes one or more processors, and memory resources represented by a memory 1932 for storing instructions executable by the processing component 1922, such as application programs. The application programs stored in the memory 1932 may include one or more modules each corresponding to a set of instructions. Memory 1932 may store any or all of the units associated above with the device of FIG. 15.

The server 1900 may also include a power component 1926 configured to perform power management of the server 1900, wired or wireless network interface(s) 1950 configured to connect the server 1900 to a network, and an input/output (I/O) interface 1958. The server 1900 may operate based on an operating system stored in the memory 1932, such as Windows Server™, Mac OS X™, Unix™, Linux™, FreeBSD™, or the like.

Each module discussed above in connection with a server of FIG. 15, such as, but not limited to, the receiving unit 21, traffic-impediment-location determining unit 22, a traffic impediment marking unit 23, and storing unit 24, may take the form of a packaged functional hardware unit designed for use with other components, a portion of a program code (e.g., software or firmware) executable by the processor of processing component 1922 or the processing circuitry that usually performs a particular function of related functions, or a self-contained hardware or software component that interfaces with a larger system, for example.

A non-transitory computer readable storage medium, the storage medium storing instructions which, when executed by the processor of the server, cause the server to perform a method for processing traffic data. Execution of the instructions may cause the server to receive, from a first vehicle, a current location of the first vehicle and an amount of variation of an impediment parameter of the first vehicle. Execution of the instructions may further cause the server to determine whether the current location corresponds to a location previously stored in a traffic-impediment-location list in the server. Execution of the instructions may further cause the server to when the current location does not correspond to a location previously stored in the traffic-impediment-location list, identify the current location as a traffic impediment location. Execution of the instructions may further cause the server to, when the current location does not correspond to a location previously stored in the traffic-impediment-location list, store the amount of variation of the impediment parameter locally in the server. Execution of the instructions may further cause the server to, when the current location does not correspond to a location previously stored in the traffic-impediment-location list, store the current location in the traffic-impediment-location list.

The methods, devices, modules, and units described above may be implemented in many different ways and as hardware, software or in different combinations of hardware and software. For example, all or parts of the implementations may be a processing circuitry that includes an instruction processor, such as a central processing unit (CPU), microcontroller, a microprocessor; or application specific integrated circuits (ASICs), digital signal processors (DSPs), digital signal processing devices (DSPDs), programmable logic devices (PLDs), field programmable gate arrays (FPGAs), controllers, micro-controllers, microprocessors, other electronic components; or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

It should be noted that, as used herein, relation terms such as “first” and “second” are used merely to distinguish a subject or an operation from another subject or another operation, and not to require or imply any substantial relation or order between these subjects or operations. Moreover, terms “include”, “contain” or any variation thereof are intended to cover an nonexclusive containing, such that a process, a method, an item or a device containing a series of elements not only includes these elements, but also includes other elements that are not set forth specifically, or also includes an inherent element of such a process, method, item or device. Without further limitation, an element defined by a phrase “include a” does not mean that other elements are excluded from the process, method, item or device including the same element.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof

The above disclosure describes some specific embodiments of the present disclosure to make those skilled in the art to understand or practice the present disclosure. Various modifications to these embodiments are apparent to those skilled in the art. The general principle defined herein can be implemented through other embodiments without departing from the spirit or scope of the present disclosure. Therefore, the present disclosure is not limited to embodiments illustrated herein, but should be given the widest scope consistent with the principle and novel features.

What is claimed is:

1. A method for processing traffic data, applied in a terminal, the method comprising:
acquiring a current location of a traveling vehicle;
determining whether the current location is an identified traffic impediment location;
when the current location is not an identified traffic impediment location:
monitoring an amount of variation of an impediment parameter when the vehicle is in the current location, and
determining whether the amount of variation of the impediment parameter exceeds a corresponding predetermined range; and
when the amount of variation of the impediment parameter exceeds the predetermined range, sending the current location and the amount of variation of the impediment parameter to a traffic data server.

2. The method of claim 1, wherein the method further comprises:
when the current location is not an identified traffic impediment location, and the amount of variation of the impediment parameter exceeds the corresponding predetermined range, identifying a time instant at which the vehicle is in the current location as a traffic impediment time instant;
acquiring traffic impediment data from the traffic impediment time instant, the traffic impediment data containing one or more of:
image data from within a first predetermined time period before the traffic impediment time instant, or
image data from within a second predetermined time period after the traffic impediment time instant; and
sending the traffic impediment data to the traffic data server.

3. The method of claim 1, wherein the method further comprises:
when the current location is an identified traffic impediment location:
detecting an amount of variation of an impediment parameter when the vehicle is in the current location,
determining whether the amount of variation of the impediment parameter does not exceed the corresponding predetermined range, and
when the amount of variation of the impediment parameter does not exceed the corresponding predetermined range, sending the amount of variation of the impediment parameter and the current location to the traffic data server.

4. The method of claim 1, wherein the method further comprises:
acquiring a traveling route of the vehicle and sending the traveling route to the traffic data server;
receiving, from the traffic data server:
each identified traffic impediment location on the traveling route, and
a respective predetermined range of an impediment parameter corresponding to each identified traffic impediment location; and
presenting, locally at the vehicle, each received identified traffic impediment location on the traveling route.

5. The method of claim 4, wherein presenting, locally at the vehicle, the received identified traffic impediment locations on the traveling route, comprises:
acquiring an image of the traveling route of the vehicle;
marking, on the image of the traveling route, the received identified traffic impediment locations on the traveling route; and
presenting, locally at the vehicle, the traveling route marked with the received identified traffic impediment locations.

6. The method of claim 5, wherein the method further comprises:
receiving from a user an inquiry request inquiring about an identified traffic impediment location on the traveling route;
sending the inquiry request to the traffic data server;
receiving traffic impediment data of the identified traffic impediment location, the received traffic impediment data of the identified traffic impediment location being a result of a search by the traffic data server based on the inquiry request; and
presenting the received traffic impediment data of the identified traffic impediment location.

7. A method for processing traffic data, applied in a server, the method comprising:
receiving, from a first vehicle, a current location of the first vehicle and an amount of variation of an impediment parameter of the first vehicle;
determining whether the current location corresponds to a location previously stored in a traffic-impediment-location list in the server; and
when the current location does not correspond to a location previously stored in the traffic-impediment-location list:
identifying the current location as a traffic impediment location,
storing the amount of variation of the impediment parameter locally in the server, and
storing the current location in the traffic-impediment-location list.

8. The method of claim 7, wherein the method further comprises:
receiving, from a second vehicle, a traveling route of the second vehicle;
determining whether an identified traffic impediment location exists on the traveling route; and
when an identified traffic impediment location exists on the traveling route, sending to the second vehicle:
each identified traffic impediment location on the traveling route, and
a respective predetermined range of an impediment parameter corresponding to each identified traffic impediment location.

9. The method of claim 7, wherein the method further comprises:
when the current location corresponds to a location previously stored in the traffic-impediment-location list, identifying as not being a traffic impediment location the identified traffic impediment location in the traffic-impediment-location list which corresponds to the current location.

10. The method of claim 7, wherein the method further comprises:
when the current location is identified as a traffic impediment location, receiving traffic impediment data of the traffic impediment location from the first vehicle, the traffic impediment data containing at least image data of the traffic impediment location; and
storing the traffic impediment data locally in the server.

11. The method of claim 10, wherein the method further comprises:
receiving, from a second vehicle, an inquiry request with respect to an identified traffic impediment location;
searching, locally in the server, for traffic impediment data corresponding to the identified traffic impediment location; and
sending, to the second vehicle, the traffic impediment data corresponding to the identified traffic impediment location.

12. The method of claim 8, wherein the first vehicle and the second vehicle are the same vehicle.

13. A terminal, comprising:
a processor; and
a memory for storing instructions executable by the processor;
wherein the processor is configured to:
acquire a current location of a traveling vehicle;
determine whether the current location is an identified traffic impediment location;
when the current location is not an identified traffic impediment location:
monitor an amount of variation of an impediment parameter when the vehicle is in the current location, and
determine whether the amount of variation of the impediment parameter exceeds a corresponding predetermined range; and
when the amount of variation of the impediment parameter exceeds the predetermined range, send the current location and the amount of variation of the impediment parameter to a traffic data server.

14. The terminal of claim 13, wherein the processor is further configured to:
when the current location is not an identified traffic impediment location, and the amount of variation of the impediment parameter exceeds the corresponding predetermined range, identify a time instant at which the vehicle is in the current location as a traffic impediment time instant;
acquire traffic impediment data from the traffic impediment time instant, the traffic impediment data containing one or more of:
image data from within a first predetermined time period before the traffic impediment time instant, or
image data from within a second predetermined time period after the traffic impediment time instant; and
send the traffic impediment data to the traffic data server.

15. The terminal of claim 13, wherein the processor is further configured to:
when the current location is an identified traffic impediment location:
detect an amount of variation of an impediment parameter when the vehicle is in the current location, and
determine whether the amount of variation of the impediment parameter does not exceed the corresponding predetermined range, and
when the amount of variation of the impediment parameter does not exceed the corresponding predetermined range, send the amount of variation of the impediment parameter and the current location to the traffic data server.

16. A server, comprising:
a processor; and
a memory for storing instructions executable by the processor;
wherein the processor is configured to:
receive, from a first vehicle, a current location of the first vehicle and an amount of variation of an impediment parameter of the first vehicle;
determine whether the current location corresponds to a location previously stored in a traffic-impediment-location list in the server; and
when the current location does not correspond to a location previously stored in the traffic-impediment-location list:
identify the current location as a traffic impediment location,
store the amount of variation of the impediment parameter locally in the server, and
store the current location in the traffic-impediment-location list.

17. The server of claim 16, wherein the processor is further configured to:
receive, from a second vehicle, a traveling route of the second vehicle;
determine whether an identified traffic impediment location exists on the traveling route; and
when an identified traffic impediment location exists on the traveling route, send to the second vehicle:
each identified traffic impediment location on the traveling route, and
a respective predetermined range of an impediment parameter corresponding to each identified traffic impediment location.

18. The server of claim 16, wherein the processor is further configured to:
when the current location corresponds to a location previously stored in the traffic-impediment-location list, identify as not being a traffic impediment location the identified traffic impediment location in the traffic-impediment-location list which corresponds to the current location.

19. The server of claim 16, wherein the processor is further configured to:
when the current location is identified as a traffic impediment location, receive traffic impediment data of the traffic impediment location from the first vehicle, the traffic impediment data containing at least image data of the traffic impediment location; and
store the traffic impediment data locally in the server.

20. The server of claim 19, wherein the processor is further configured to:
receive, from a second vehicle, an inquiry request with respect to an identified traffic impediment location;
search, locally in the server, for traffic impediment data corresponding to the identified traffic impediment location; and
send, to the second vehicle, the traffic impediment data corresponding to the identified traffic impediment location.
